(19) United States
(12) Patent Application Publication
(10) Pub. No.: US 2015/0257473 A1
(43) Pub. Date: Sep. 17, 2015

(54) INTEGRATED SHOE AND METHOD OF MAKING THE SAME

(71) Applicant: SUNKO INK CO., LTD., Taichung (TW)

(72) Inventors: Chia-Pang Liu, Taichung (TW); Ting-Kai Huang, Taichung (TW); Yi-Jung Huang, Taichung (TW)

(73) Assignee: SUNKO INK CO., LTD., Taichung (TW)

(21) Appl. No.: 14/208,194

(22) Filed: Mar. 13, 2014

(51) Int. Cl. A43B 1/14; B29D 35/00; B29D 35/04; B29C 44/12

(52) U.S. Cl. CPC A43B 1/14; B29C 44/1285; B29D 35/0009; B29D 35/04; B29K 2105/0005

(57) ABSTRACT

An integrated shoe comprises a first part and a second part directly attached to the first part. A method of making the integrated shoe comprises steps of injecting a first thermoplastic polymer mixture into a mold to obtain a first semi-molding part; injecting a second thermoplastic polymer mixture into the mold to obtain a second semi-molding part directly attached to a side surface of the first semi-molding part; and aging the first semi-molding part and the second semi-molding part to form a first part and a second part directly attached to the first part and obtain the integrated shoe. By omitting an adhesive layer, fabrication costs of the integrated shoe are lowered; in addition, yield of the method of making the integrated shoe is raised.

### BACKGROUND OF THE INVENTION

1. Field of the Invention

The present invention relates to a shoe and a method of making the shoe; particularly relates to an integrated shoe and a method of making the integrated shoe.

2. Description of the Prior Art(s)

With reference to FIGS. 4 to 6, a conventional method for making a shoe is as follows. A thermoplastic polymer is injected by an injection molding machine to fabricate a sole 30. Another thermoplastic polymer is injected by another injection molding machine to fabricate an upper 40. Then an adhesive layer 50 is mounted between the sole 30 and the upper 40 to combine the sole 30 and the upper 40, so as to fabricate the shoe.

However, a two-step injection molding process is adopted in the conventional method for making a shoe to fabricate the sole 30 and the upper 40. Also, after the sole 30 and the upper 40 are respectively fabricated, the adhesive layer 50 has to be applied to combine the sole 30 and the upper 40 and complete the fabrication of the shoe. As such, the conventional method for making a shoe simultaneously uses multiple injection molding machines for fabricating the shoe. Besides, hours or even days of time and complex fabrication steps are needed in order to obtain the shoe. Therefore, the conventional method for making a shoe has shortcomings of high fabrication costs and low yield.

To overcome the shortcomings, the present invention provides an integrated shoe without an adhesive layer and a method for making the shoe to mitigate or obviate the aforementioned problems.

### SUMMARY OF THE INVENTION

The main objective of the present invention is to provide an integrated shoe having benefits of low fabrication costs, and a method of making the integrated shoe with high yield of production.

The integrated shoe in accordance with the present invention comprises a first part and a second part directly attached to the first part. The first part includes a first thermoplastic polymer mixture. The second part includes a second thermoplastic polymer mixture.

The description “a second part directly attached to the first part” refers to that the first part and the second part are connected to each other seamlessly; that is, the first part and the second part are integrally formed as a single piece without use of any adhesive layer.

Further, the first thermoplastic polymer mixture includes at least one thermoplastic polymer. The second thermoplastic polymer mixture includes at least one thermoplastic polymer. The first thermoplastic polymer mixture and the second thermoplastic polymer mixture are compatible to each other.

The method of making the integrated shoe in accordance with the present invention is as follows.

The first thermoplastic polymer mixture is injected into a mold to obtain a first semi-molding part. The second thermoplastic polymer mixture is injected into the mold to obtain a second semi-molding part directly attached to a side surface of the first semi-molding part. The first semi-molding part and the second semi-molding part are aged to form the first part and the second part directly attached to the first part, so as to obtain the integrated shoe.

Preferably, the first semi-molding part and the second semi-molding part are aged for a time ranging from 50 seconds to 130 seconds to form the first part and the second part directly attached to the side surface of the first semi-molding part, so as to obtain the integrated shoe.

Preferably, the first thermoplastic polymer mixture is melted and injected into the mold under a temperature ranging from 130° C. to 215° C. Then a cooling for 10 seconds to 140 seconds is followed after the injection to obtain the first semi-molding part. The second thermoplastic polymer mixture is melted and injected into the mold under a temperature ranging from 130° C. to 215° C. to obtain the second semi-molding part directly attached to the side surface of the first semi-molding part.

Preferably, the first thermoplastic polymer mixture comprises at least one thermoplastic polymer selected from a group consisting of thermoplastic polyurethane (TPU), polyethylene (PE), polypropylene (PP), polyvinylchloride (PVC), polyethylene terephthalate (PET), polystyrene (PS), acrylonitrile butadiene styrene copolymer (ABS), polyamide (PA), polymethyl methacrylate (PMMA), polytetrafluoroethylene (PTFE), polycarbonate (PC), thermoplastic vulcanizate (TPV), polyisoprene rubber (IR), polybutadiene rubber (BR), acrylonitrile butadiene rubber (NBR), styrene-butadiene rubber copolymer (SBR), styrene-ethylene-butylene-styrene block copolymer (SEBS), styrene-isoprene-styrene block copolymer (SIS) and a chemically modified product thereof.

The chemically modified product of the thermoplastic polymer of the first thermoplastic polymer mixture is designated to a product that is produced by connecting one polymer and another polymer via a chemical method. For example, but not limited thereto, the chemically modified product of the thermoplastic polymer of the first thermoplastic polymer mixture is maleic anhydride (MA) grafted styrene-ethylene-butylene-styrene block copolymer.

Preferably, the second thermoplastic polymer mixture comprises at least one thermoplastic polymer selected from a group consisting of thermoplastic polyurethane (TPU), polyethylene (PE), polypropylene (PP), polyvinylchloride (PVC), polyethylene terephthalate (PET), polystyrene (PS), acrylonitrile butadiene styrene copolymer (ABS), polyamide (PA), polymethyl methacrylate (PMMA), polytetrafluoroethylene (PTFE), polycarbonate (PC), thermoplastic vulcanizate (TPV), polyisoprene rubber (PIR), polybutadiene rubber (PBR), acrylonitrile butadiene rubber (NBR), styrene-butadiene rubber copolymer (SBR), styrene-ethylene-butylene-styrene block copolymer (SEBS), styrene-isoprene-styrene block copolymer (SIS) and a chemically modified product thereof.

The chemically modified product of the thermoplastic polymer of the second thermoplastic polymer mixture is designated to a product that is produced by connecting one polymer and another polymer via a chemical method. For example, but not limited thereto, the chemically modified product of the thermoplastic polymer of the second thermoplastic polymer mixture is maleic anhydride (MA) grafted styrene-ethylene-butylene-styrene block copolymer.

Preferably, the first thermoplastic polymer mixture comprises a first expanding agent including a compound that changes volume or generates gas after being heated.

Preferably, the second thermoplastic polymer mixture comprises a second expanding agent including a compound that changes volume or generates gas after being heated.

More preferably, the compound of the first expanding agent is selected from a group consisting of azodicarbonamide, ethylene vinyl acetate (EVA) and ammonium carbonate (AMC). The content of the first expanding agent is 0.1 weight percent (wt %) to 20 weight percents based on the weight of the first thermoplastic polymer mixture.

More preferably, the compound of the second expanding agent is selected from a group consisting of azodicarbonamide, ethylene vinyl acetate and ammonium carbonate. The content of the second expanding agent is 0.1 wt % to 20 wt % based on the weight of the second thermoplastic polymer mixture.

Preferably, the first thermoplastic polymer mixture comprises an antiwear agent.

More preferably, the antiwear agent comprises a substance selected from a group consisting of silicon, graphite and fiber.

Preferably, the first part is a sole and the second part is an upper of the shoe.

Since the second part is directly attached to the first part and the use of an adhesive layer is omitted, fabrication steps of the integrated shoe in accordance with the present invention is simplified and fabrication time is reduced, thereby resulting in low fabrication costs and high yield of the integrated shoe.

Under an elevated temperature, both the first thermoplastic polymer mixture and the second thermoplastic polymer mixture are in molten state, and the first semi-molding part in semi-molten state is formed by the first thermoplastic polymer mixture and directly attached to the second semi-molding part in semi-molten state formed by the second thermoplastic polymer mixture. After aging, the first part and the second part are formed and the integrated shoe is obtained. Accordingly, use of an adhesive layer is omitted and the fabrication time of the integrated shoe is shortened to less than 300 seconds. Therefore, the method of making the integrated shoe in accordance with the present invention has benefits of low fabrication costs and high yield.

Other objectives, advantages and novel features of the invention will become more apparent from the following detailed description when taken in conjunction with the accompanying drawings.

### BRIEF DESCRIPTION OF THE DRAWINGS

FIG. 1 is a flow diagram of Embodiment 1 of a method of making an integrated shoe in accordance with the present invention.

FIG. 2 is an exploded perspective view of Embodiment 1 of an integrated shoe in accordance with the present invention.

FIG. 3 is a perspective view of Embodiment 1 of an integrated shoe in accordance with the present invention.

FIG. 4 is a flow diagram of a method of making a shoe in accordance with the prior art.

FIG. 5 is an exploded perspective view of a shoe in accordance with the prior art.

FIG. 6 is a perspective view of a shoe in accordance with the prior art.

### DETAILED DESCRIPTION OF THE PREFERRED EMBODIMENTS

For a better understanding about the technical features of the present invention and its effect, and for implements in accordance with the disclosures of the specification, embodiments, details and figures are further shown as follows.

### Embodiment 1

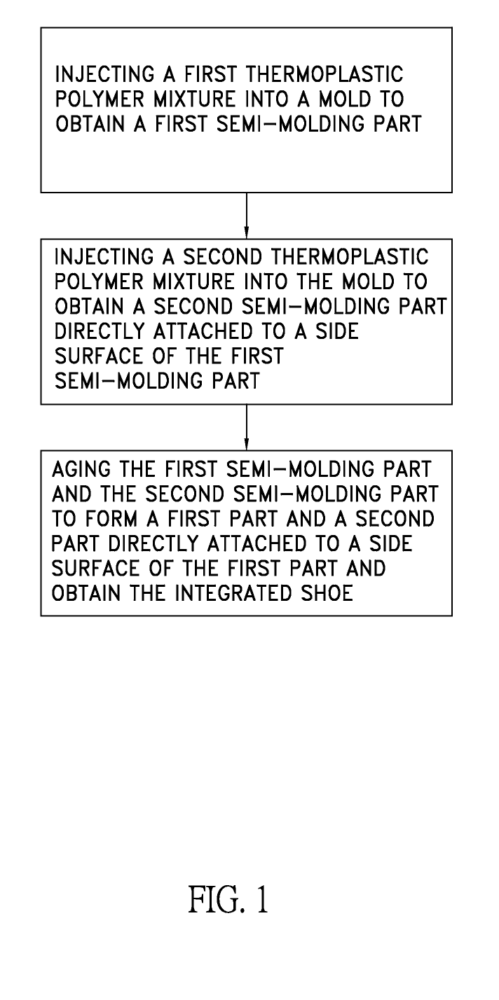

With reference to FIG. 1, a method of making an integrated shoe of Embodiment 1 in accordance with the present invention was described as follows. A first thermoplastic polymer mixture was melted and injected by an injection molding machine into a mold under a temperature of 195° C. After cooling the injected first thermoplastic polymer mixture for 15 seconds, a first semi-molding part was obtained.

A second thermoplastic polymer mixture was melted and injected by the injection molding machine into the mold under a temperature of 195° C. and a second semi-molding part directly attached to a side surface of the first semi-molding part was obtained.

The first semi-molding part and the second semi-molding part were aged for 80 seconds to form a first part and a second part directly attached to the first part, and the integrated shoe was obtained.

In the present embodiment, the first thermoplastic polymer mixture comprised a thermoplastic polyurethane, which was T795M manufactured by Sunko Ink. Co., Ltd. The second thermoplastic polymer mixture comprised a thermoplastic polyurethane, which was T975LM2 manufactured by Sunko Ink. Co., Ltd.

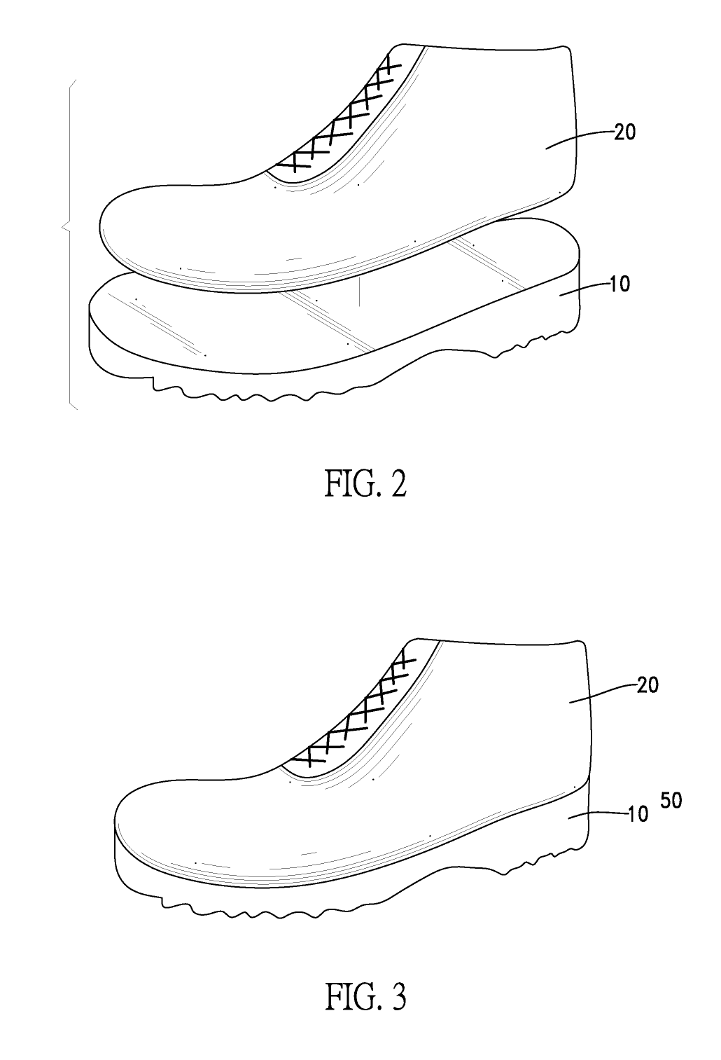

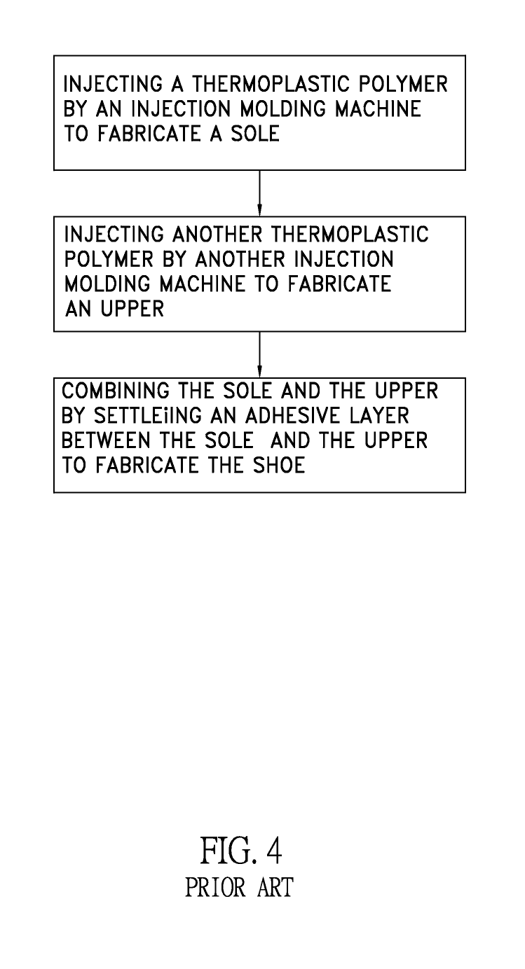

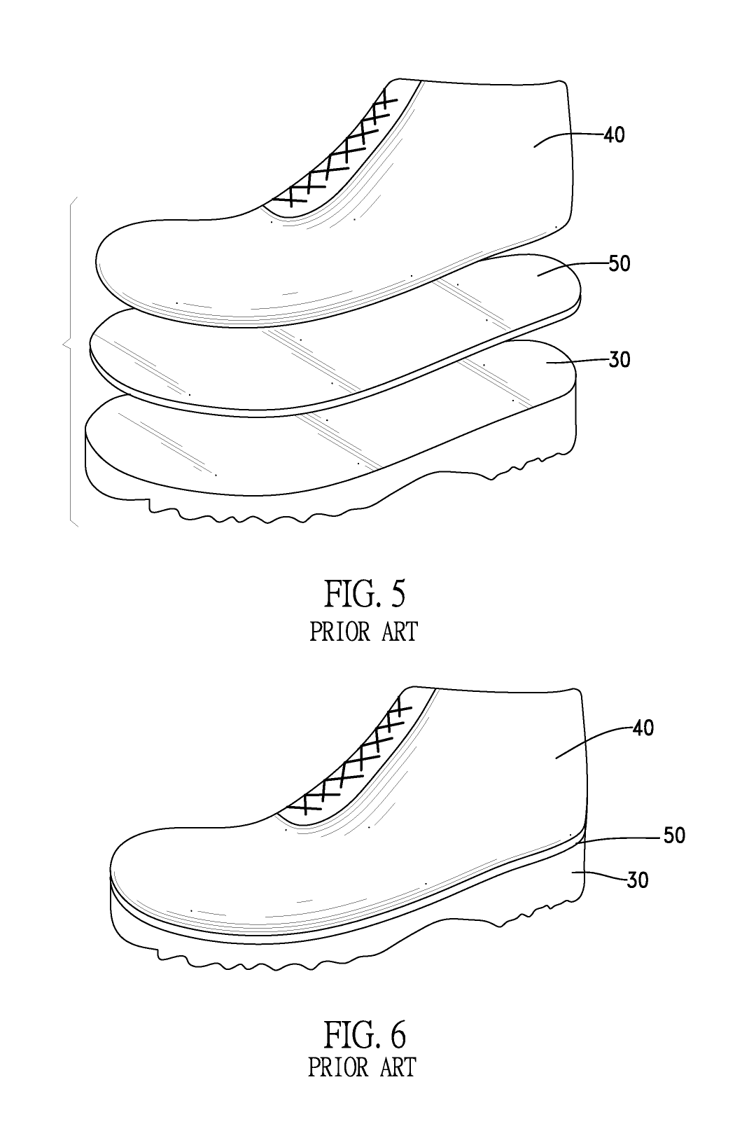

FIGS. 2 and 3 show the integrated shoe manufactured by the method of making an integrated shoe of the present embodiment, the first part 10 was a sole and the second part 20 was an upper of the integrated shoe.

### Embodiment 2

The present embodiment was similar to Embodiment 1. The differences between the present embodiment and Embodiment 1 were as follows.

In the method of making an integrated shoe of the present embodiment, a first thermoplastic polymer mixture was melted and injected under a temperature of 180° C. and followed by cooling for 80 seconds to obtain a first semi-molding part. A second thermoplastic polymer mixture was melted and injected under a temperature of 180° C. to obtain a second semi-molding part. The first semi-molding part and the second semi-molding part were aged for 100 seconds to obtain the integrated shoe.

In the present embodiment, the first thermoplastic polymer mixture comprised a thermoplastic polyurethane and a first expanding agent. The thermoplastic polyurethane was T975LM2 manufactured by Sunko Ink. Co., Ltd. The first expanding agent was 950MB80 manufactured by Akzo Nobel. The first expanding agent comprised ethylene vinyl acetate, and the content of the first expanding agent was 5 wt % based on the weight of the first thermoplastic polymer mixture.

### Embodiment 3

The present embodiment was similar to Embodiment 1. The differences between the present embodiment and Embodiment 1 were as follows.

In the method of making an integrated shoe of the present embodiment, a first thermoplastic polymer mixture was melted and injected into the mold and followed by cooling for 25 seconds to obtain a first semi-molding part. A second thermoplastic polymer mixture was melted and injected to obtain a second semi-molding part. The first semi-molding part and the second semi-molding part were aged for 80 seconds to obtain the integrated shoe. In the present embodiment, the first thermoplastic polymer mixture comprised a thermoplastic polyurethane, which was T975LM2 manufactured by Sunko Ink. Co., Ltd. The second thermoplastic polymer mixture comprised thermoplastic polyurethane manufactured by BASF Co. and with a hardness of 75 A.

### Embodiment 4

The present embodiment was similar to Embodiment 1. The differences between the present embodiment and Embodiment 1 were as follows.

In the method of making an integrated shoe of the present embodiment, a first thermoplastic polymer mixture was melted and injected under a temperature of 150° C. and followed by cooling for 120 seconds to obtain a first semi-molding part. A second thermoplastic polymer mixture was melted and injected under a temperature of 150° C. to obtain a second semi-molding part. The first semi-molding part and the second semi-molding part were aged for 120 seconds to obtain the integrated shoe.

In the present embodiment, the first thermoplastic polymer mixture comprised a thermoplastic polyurethane and a first expanding agent. The thermoplastic polyurethane of the first thermoplastic polymer mixture was manufactured by Bayer Co. The first expanding agent was 950MB120 manufactured by Akzo Nobel. The first expanding agent comprised ethylene vinyl acetate, and the content of the first expanding agent was 8 wt % based on the weight of the first thermoplastic polymer mixture. The second thermoplastic polymer mixture comprised a thermoplastic polyurethane. The thermoplastic polyurethane of the second thermoplastic polymer mixture was T965LNM2 manufactured by Sunko Ink. Co., Ltd.

### Embodiment 5

The present embodiment was similar to Embodiment 1. The differences between the present embodiment and Embodiment 1 were as follows.

In the method of making an integrated shoe of the present embodiment, a first thermoplastic polymer mixture was melted and injected under a temperature of 160° C. and followed by cooling for 120 seconds to obtain a first semi-molding part. A second thermoplastic polymer mixture was melted and injected under a temperature of 150° C. to obtain a second semi-molding part. The first semi-molding part and the second semi-molding part were aged for 60 seconds to obtain the integrated shoe.

In the present embodiment, the first thermoplastic polymer mixture comprised a thermoplastic polyurethane and a first expanding agent. The thermoplastic polyurethane of the first thermoplastic polymer mixture was T965LNM2 manufactured by Sunko Ink. Co., Ltd. The first expanding agent was 950MB120 manufactured by Akzo Nobel. The content of the first expanding agent was 5 wt % based on the weight of the first thermoplastic polymer mixture. The second thermoplastic polymer mixture comprised a thermoplastic vulcanizate. The thermoplastic vulcanizate of the second thermoplastic polymer mixture was KP-501N55 manufactured by Kuo Ching Chem. Co., Ltd.

### Embodiment 6

The present embodiment was similar to Embodiment 1. The differences between the present embodiment and Embodiment 1 were as follows.

In the method of making an integrated shoe of the present embodiment, a first thermoplastic polymer mixture was melted and injected under a temperature of 150° C. and followed by cooling for 80 seconds to obtain a first semi-molding part. A second thermoplastic polymer mixture was melted and injected under a temperature of 150° C. to obtain a second semi-molding part. The first semi-molding part and the second semi-molding part were aged for 65 seconds to obtain the integrated shoe.

In the present embodiment, the first thermoplastic polymer mixture comprised a thermoplastic polyurethane and a first expanding agent. The thermoplastic polyurethane of the first thermoplastic polymer mixture was T965LNM2 manufactured by Sunko Ink. Co., Ltd. The first expanding agent was 950MB120 manufactured by Akzo Nobel. The content of the first expanding agent was 3 wt % based on the weight of the first thermoplastic polymer mixture. The second thermoplastic polymer mixture comprised a thermoplastic vulcanizate and a second expanding agent. The thermoplastic vulcanizate of the second thermoplastic polymer mixture was KP-501N55 manufactured by Kuo Ching Chem. Co., Ltd. The second expanding agent was 950MB120 manufactured by Akzo Nobel. The content of the second expanding agent was 5 wt % based on the weight of the second thermoplastic polymer mixture.

### Embodiment 7

The present embodiment was similar to Embodiment 1. The differences between the present embodiment and Embodiment 1 were as follows.

In the method of making an integrated shoe of the present embodiment, a first thermoplastic polymer mixture was melted and injected under a temperature of 150° C. and followed by cooling for 30 seconds to obtain a first semi-molding part. A second thermoplastic polymer mixture was melted and injected under a temperature of 150° C. to obtain a second semi-molding part. The first semi-molding part and the second semi-molding part were aged for 100 seconds to obtain the integrated shoe.

In the present embodiment, the first thermoplastic polymer mixture comprised a thermoplastic vulcanizate. The thermoplastic vulcanizate of the first thermoplastic polymer mixture was KP-501N55 manufactured by Kuo Ching Chem. Co., Ltd. The second thermoplastic polymer mixture comprised a styrene butadiene styrene block copolymer. The styrene butadiene styrene block copolymer of the second thermoplastic polymer mixture was Taipol 3206 manufactured by TSRC Co.

Based on the above, since the second part was directly attached to the first part, the use of an adhesive layer was omitted. Therefore, fabrication steps of the integrated shoe of the present invention were simple and fabrication time was shortened, resulting in low fabrication costs and high yield of the integrated shoe.

Under an elevated temperature, both the first thermoplastic polymer mixture and the second thermoplastic polymer mixture are in molten state, and the first semi-molding part in semi-molten state is formed by the first thermoplastic polymer mixture and directly attached to the second semi-molding part in semi-molten state formed by the second thermoplastic polymer mixture. After aging, the first part and the second part are formed and the integrated shoe is obtained. Accordingly, use of an adhesive layer is omitted and the fabrication time of the integrated shoe is shortened to less than 300 seconds. Therefore, the method of making the integrated shoe in accordance with the present invention has benefits of low fabrication costs and high yield.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An integrated shoe comprising:
a first part including
a first thermoplastic polymer mixture including
at least one thermoplastic polymer; and
a second part directly attached to the first part, the second part including
a second thermoplastic polymer mixture including
at least one thermoplastic polymer.

2. The integrated shoe as claimed in claim 1, wherein the first thermoplastic polymer mixture includes
a content of a expanding agent ranging from 0.1 weight percent to 20 weight percents based on a weight of the first thermoplastic polymer mixture, the expanding agent including
a compound that changes volume or generates gas after being heated.

3. The integrated shoe as claimed in claim 2, wherein the second thermoplastic polymer mixture includes
a content of a expanding agent ranging from 0.1 weight percent and 20 weight percents based on a weight of the second thermoplastic polymer mixture, the expanding agent including
a compound that changes volume or generates gas after being heated.

4. The integrated shoe as claimed in claim 2, wherein the compound of the expanding agent of the first thermoplastic polymer mixture is selected from a group consisting of: azodicarbonamide, ethylene vinyl acetate and ammonium carbonate.

5. The integrated shoe as claimed in claim 3, wherein the compound of the expanding agent of the second thermoplastic polymer mixture is selected from a group consisting of: azodicarbonamide, ethylene vinyl acetate and ammonium carbonate.

6. The integrated shoe as claimed in claim 1, wherein the at least one thermoplastic polymer of the first thermoplastic polymer mixture is selected from a group consisting of: thermoplastic polyurethane, polyethylene, polypropylene, polyvinylchloride, polyethylene terephthalate, polystyrene, acrylonitrile butadiene styrene copolymer, polyamide, polymethyl methacrylate, polytetrafluoroethylene, polycarbonate, thermoplastic vulcanizate, polyisoprene rubber, polybutadiene rubber, acrylonitrile butadiene rubber, styrene-butadiene rubber copolymer, styrene-ethylene-butylene-styrene block copolymer, styrene-isoprene-styrene block copolymer and a chemically modified product thereof.

7. The integrated shoe as claimed in claim 1, wherein the at least one thermoplastic polymer of the second thermoplastic polymer mixture is selected from a group consisting of: thermoplastic polyurethane, polyethylene, polypropylene, polyvinylchloride, polyethylene terephthalate, polystyrene, acrylonitrile butadiene styrene copolymer, polyamide, polymethyl methacrylate, polytetrafluoroethylene, polycarbonate, thermoplastic vulcanizate, polyisoprene rubber, polybutadiene rubber, acrylonitrile butadiene rubber, styrene-butadiene rubber copolymer, styrene-ethylene-butylene-styrene block copolymer, styrene-isoprene-styrene block copolymer and a chemically modified product thereof.

8. The integrated shoe as claimed in claim 1, wherein the first thermoplastic polymer mixture includes
an antiwear agent.

9. The integrated shoe as claimed in claim 8, wherein the antiwear agent of the first thermoplastic polymer mixture is selected from a group consisting of: silicon, graphite and fiber.

10. The integrated shoe as claimed in claim 8, wherein the first part is a sole and the second part is an upper.

11. A method of making an integrated shoe comprising steps of:
injecting a first thermoplastic polymer mixture into a mold to obtain a first semi-molding part, wherein the first thermoplastic polymer mixture includes at least one thermoplastic polymer;
injecting a second thermoplastic polymer mixture into the mold to obtain a second semi-molding part directly attached to a side surface of the first semi-molding part, wherein the second thermoplastic polymer mixture includes at least one thermoplastic polymer; and
aging the first semi-molding part and the second semi-molding part to obtain the integrated shoe, wherein the integrated shoe comprises a first part and a second part directly attached to the first part.

12. The method of making the integrated shoe as claimed in claim 11, wherein the step of aging the first semi-molding part and the second semi-molding part to form a first part and a second part directly attached to the first part and obtain the integrated shoe comprises
aging the first semi-molding part and the second semi-molding part for a time ranging from 50 seconds to 130 seconds to form the first part and the second part directly attached to the first part and obtain the integrated shoe.

13. The method of making the integrated shoe as claimed in claim 11, wherein the step of injecting a first thermoplastic polymer mixture into a mold to obtain a first semi-molding part comprises
melting and injecting the first thermoplastic polymer mixture into the mold under a temperature ranging from 130° C. to 215° C., and cooling for 10 seconds to 140 seconds to obtain the first semi-molding part; and
the step of injecting a second thermoplastic polymer mixture into the mold to obtain a second semi-molding part directly attached to a side surface of the first semi-molding part comprises
melting and injecting the second thermoplastic polymer mixture into the mold under a temperature ranging from 130° C. to 215° C. to obtain the second semi-molding part.

14. The method of making the integrated shoe as claimed in claim 13, wherein the step of injecting a first thermoplastic polymer mixture into a mold to obtain a first semi-molding part comprises
injecting the first thermoplastic polymer mixture including a content of a expanding agent ranging from 0.1 weight percent and 20 weight percents based on a weight of the second thermoplastic polymer mixture into the mold to obtain the first semi-molding part, wherein the expanding agent includes a compound that changes volume or generates gas after being heated.

15. The method of making the integrated shoe as claimed in claim 14, wherein the step of injecting a second thermoplastic polymer mixture into the mold to obtain a second semi-molding part directly attached to a side surface of the first semi-molding part comprises
injecting the second thermoplastic polymer mixture including a content of a expanding agent ranging from 0.1 weight percent and 20 weight percents based on a weight of the second thermoplastic polymer mixture into the mold to obtain the second semi-molding part, wherein the expanding agent includes a compound that changes volume or generates gas after being heated.

16. The method of making the integrated shoe as claimed in claim 14, wherein the step of injecting the first thermoplastic polymer mixture including a first expanding agent into the mold to obtain the first semi-molding part comprises
injecting the first thermoplastic polymer mixture including the first expanding agent which includes the compound selected from a group consisting of: azodicarbonamide, ethylene vinyl acetate and ammonium carbonate into the mold to obtain the first semi-molding part.

17. The method of making the integrated shoe as claimed in claim 15, wherein the step of injecting the second thermoplastic polymer mixture including a second expanding agent into the mold to obtain the second semi-molding part directly attached to the side surface of the first semi-molding part comprises
injecting the second thermoplastic polymer mixture including the second expanding agent which includes the compound selected from a group consisting of: azodicarbonamide, ethylene vinyl acetate and ammonium carbonate into the mold to obtain the second semi-molding part.

18. The method of making the integrated shoe as claimed in claim 11, wherein the step of injecting a first thermoplastic polymer mixture into a mold to obtain a first semi-molding part comprises
injecting the first thermoplastic polymer mixture including at least one thermoplastic polymer selected from a group consisting of: thermoplastic polyurethane, polyethylene, polypropylene, polyvinylchloride, polyethylene terephthalate, polystyrene, acrylonitrile butadiene styrene copolymer, polyamide, polymethyl methacrylate, polytetrafluoroethylene, polycarbonate, thermoplastic vulcanizate, polyisoprene rubber, polybutadiene rubber, acrylonitrile butadiene rubber, styrene-butadiene rubber copolymer, styrene-ethylene-butylene-styrene block copolymer, styrene-isoprene-styrene block copolymer and a chemically modified product thereof into the mold to obtain the first semi-molding part.

19. The method of making the integrated shoe as claimed in claim 11, wherein the step of injecting a second thermoplastic polymer mixture into the mold to obtain a second semi-molding part directly attached to a side surface of the first semi-molding part comprises
injecting the second thermoplastic polymer mixture including at least one thermoplastic polymer selected from a group consisting of: thermoplastic polyurethane, polyethylene, polypropylene, polyvinylchloride, polyethylene terephthalate, polystyrene, acrylonitrile butadiene styrene copolymer, polyamide, polymethyl methacrylate, polytetrafluoroethylene, polycarbonate, thermoplastic vulcanizate, polyisoprene rubber, polybutadiene rubber, acrylonitrile butadiene rubber, styrene-butadiene rubber copolymer, styrene-ethylene-butylene-styrene block copolymer, styrene-isoprene-styrene block copolymer and a chemically modified product thereof into the mold to obtain the second semi-molding part directly attached to the side surface of the first semi-molding part.

20. The method of making the integrated shoe as claimed in claim 11, wherein the step of injecting a first thermoplastic polymer mixture into a mold to obtain a first semi-molding part comprises:
injecting the first thermoplastic polymer mixture including an antiwear agent into the mold to obtain the first semi-molding part.

21. The method of making the integrated shoe as claimed in claim 20, wherein the step of injecting the first thermoplastic polymer mixture including an antiwear agent into the mold to obtain the first semi-molding part comprises:
injecting the first thermoplastic polymer mixture including the antiwear agent selected from a group consisting of: silicon, graphite and fiber into the mold to obtain the first semi-molding part.

22. The method of making the integrated shoe as claimed in claim 20, wherein the step of injecting the first thermoplastic polymer mixture including an antiwear agent into the mold to obtain the first semi-molding part comprises:
injecting the first thermoplastic polymer mixture including the antiwear agent to obtain the first semi-molding part; and
the step of aging the first semi-molding part and the second semi-molding part to form a first part and a second part directly attached to a the first part and obtain the integrated shoe comprises
aging the first semi-molding part and the second semi-molding part to form the first part as a sole and the second part directly attached to the first part as an upper and obtain the integrated shoe.
